(19) United States
(12) Patent Application Publication
(10) Pub. No.: US 2026/0152649 A1
(43) Pub. Date: Jun. 4, 2026

(54) MULTILAYER COATING FILM

(71) Applicant: NIPPON PAINT AUTOMOTIVE COATINGS CO., LTD., Osaka (JP)

(72) Inventors: Ryoga KATAOKA, Osaka (JP); Ryohei TSUBONE, Osaka (JP); Shinichi FUJIWARA, Osaka (JP)

(73) Assignee: NIPPON PAINT AUTOMOTIVE COATINGS CO., LTD., Osaka (JP)

(21) Appl. No.: 19/401,966

(22) Filed: Nov. 26, 2025

(30) Foreign Application Priority Data
Nov. 29, 2024 (JP) 2024-208397

(51) Int. Cl. C09D 5/36; C09D 5/02; C09D 133/04

(52) U.S. Cl. CPC C09D 5/36; C09D 5/022; C09D 5/028; C09D 133/04

(57) ABSTRACT

The present disclosure provides a multilayer coating film having a hiding property and being capable of exhibiting dichroism due to a difference in light intensity, and preferably provides a multilayer coating film having a hiding property and being capable of exhibiting dichroism due to light intensity even if the coating film has a solid color.

A multilayer coating film comprising: an intermediate coating layer; a base layer overlaid on the intermediate coating layer; and a clear layer overlaid on the base layer,

wherein a lightness L*45 is 3 to 10, a degree of yellowness b*45 is −4 or less, and a chroma C*_{ab}45 is 4 to 10, based on a spectral reflectance at a light source 100%,
wherein a lightness L*45 is 3 or less, a degree of yellowness b*45 is −3 to 0, and a chroma C*_{ab}45 is 3 or less, based on a spectral reflectance at a light source 10%, and
wherein a content of a coloring pigment in the base layer is 2.5 parts by mass or more per 100 parts by mass of a solid content of the base layer.

### TECHNICAL FIELD

The present disclosure relates to a multilayer coating film.

### BACKGROUND ART

On the surface of an article to be coated such as an automobile body is formed sequentially a plurality of coating films (a multilayer coating film) having various roles, and thus the article is protected and concurrently is provided with a beautiful appearance and a superior design. A common method for forming such a multilayer coating film is forming an undercoating film such as an electrodeposition coating film on an article to be coated that is superior in conductivity, and then an intermediate coating film and further a top coating film are formed thereon sequentially according to necessity. Among these coating films, a top coating film including a base coating film has a great influence particularly on the appearance and design of a coating film.

In particular, the appearance of a coating film formed on an automobile is greatly involved in an appearance value such as a luxurious feeling of the automobile. In addition, customers (consumers) who purchase automobiles tend to seek automobiles having a coating film with superior designability. Due to such diversification and individuality of consumers' preferences, more unique designs are demanded.

Patent Document 1 describes that in a multilayer coating film including a first coating film, a second coating film, and a clear coating film arranged in this order, wherein the first coating film is a cured coating film of a first coating composition containing a first coating film forming resin and a luster pigment, the second coating film is a cured coating film of a second coating composition containing a second coating film forming resin and a coloring pigment, and the multilayer coating film has a C*15/L*15 value of 3 or more at an incidence angle of 45° and a light-receiving angle of 15°, a C* value of 70 or more at an incidence angle of 45° and a light-receiving angle of 15°, and a graininess value (G value) of 1 or less at an incidence angle of 45°.

Patent Document 2 describes a method for forming a multilayer coating film, including the following steps (1) to (4);
step (1): applying a titanium oxide pigment-containing first colored coating material (X) to form a first colored coating film, in which at least one of the diffuse reflectance at a wavelength of 905 nm and diffuse reflectance at a wavelength of 1550 nm is 40% or more,
step (2): applying a second colored coating material (Y) containing a carbon black pigment (A) and at least one (B) among a perylene black pigment (B1) and two or more pigments (B2) selected from the group consisting of bluish pigments, reddish pigments, yellowish pigments, and greenish pigments, to the first colored coating film to form a second colored coating film,
step (3): applying a clear coating material (Z) to the second colored coating film to form a clear coating film, and
step (4): heating the first colored coating film formed in step (1), the second colored coating film formed in step (2), and the clear coating film formed in step (3) separately or simultaneously to cure these films,
wherein the multilayer coating film has a lightness) L* (45° of 4 or less, the multilayer coating film has a chroma) C* (45° of 2 or less, and at least one of the diffuse reflectance at a wavelength of 905 nm and the diffuse reflectance at a wavelength of 1550 nm of the multilayer coating film is 10% or more.

Patent Document 3 describes a coating composition containing a black pigment that reflects and/or transmits infrared rays and a transparent blue pigment, wherein the lightness L* in the L*a*b* color system of a coating film obtained by coating is within the range of 0.1 to 7.

Patent Document 4 describes a heat-insulating coating composition for forming a heat-insulating coating film having an infrared wavelength range reflectance in a wavelength range of 800 to 2100 nm of 30% or more, a lightness L* value in the range of 20 to 40, and a chroma C value in the range of 3 to 30. The patent document also describes that the heat-insulating coating composition is prepared by a subtractive color mixing method of coloring pigments; the heat-insulating coating composition contains, as a coloring pigment, two or more coloring pigments having an infrared wavelength region reflectance of 30% or more in a wavelength region of 800 to 2100 nm selected from the group consisting of a purplish pigment, a blue pigment, a red pigment, and a green pigment; at least one among the coloring pigments contained is a highly hiding pigment with which a color difference (ΔE value) between a white base part and a black base part on a black-and-white hiding test paper of 5.0 or less in a coating film containing only the coloring pigment in a pigment concentration (PWC) of 10% by weight and having a dried film thickness of 13 μm; and the highly hiding pigment is contained in a pigment concentration (PWC) of 4% by weight or more.

Patent Document 5 describes a coating film structure in which a coating film layer of a color base coating material (A) containing a coloring pigment, a coating film layer of a metallic base coating material (B) with which the lightness difference ΔL is 30 or less, the hue difference Δh is 50 or less, and the chroma difference ΔC is 30 or less in the L*C*h color system from the coating film of the color base coating material (A), and a coating film of a top clear coating material (C) are overlaid on a base material.

### PATENT DOCUMENTS

Patent Document 1: JP-A-2022-094523
Patent Document 2: JP-A-2022-008000
Patent Document 3: JP-A-2014-210856
Patent Document 4: JP-A-2009-286862
Patent Document 5: JP-A-2005-205262

### SUMMARY

### Problems to be Solved by the Invention

A property in which the perceived color differs depending on the intensity and angle of a light beam is also referred to as dichroism. Conventionally, attempts have been made to develop different colors depending on the observing angle using a scaly pigment having a sparkle texture. Among conventionally known coating films, however, it has not been confirmed that dichroism is exhibited in a so-called solid color coating film free of a scaly pigment. In addition, it has been confirmed that a solid color is easily affected by a substrate.

An object of the present disclosure is to provide a multilayer coating film having a hiding property and being capable of exhibiting dichroism due to a difference in light intensity, and preferably to provide a multilayer coating film having a hiding property and being capable of exhibiting dichroism due to light intensity even if the coating film has a solid color.

### Solutions to the Problems

The present disclosure comprises the following embodiments.

[1]

A multilayer coating film comprising: an intermediate coating layer; a base layer overlaid on the intermediate coating layer; and a clear layer overlaid on the base layer,
wherein a lightness L*45 is 3 to 10, a degree of yellowness b*45 is −4 or less, and a chroma C*_{ab}45 is 4 to 10, based on a spectral reflectance at a light source 100%,
wherein a lightness L*45 is 3 or less, a degree of yellowness b*45 is −3 to 0, and a chroma C*_{ab}45 is 3 or less, based on a spectral reflectance at a light source 10%, and
wherein a content of a coloring pigment in the base layer is 2.5 parts by mass or more per 100 parts by mass of a solid content of the base layer.
   [2]

The multilayer coating film according to [1], wherein the base layer comprises a resin and one or more blue pigments, and
wherein a content of the blue pigments in the base layer is 2 to 20 parts by mass per 100 parts by mass of a solid content of the base layer.
   [3]

The multilayer coating film according to [2], wherein the base layer further comprises one or more black pigments,
wherein a content of the black pigments in the base layer is 0.5 to 2 parts by mass per 100 parts by mass of a solid content of the base layer, and a mass ratio of the black pigments to the blue pigments (black pigments: blue pigments) is 1:4-1:15.
   [4]

The multilayer coating film according to [3], wherein the base layer further comprises one or more white pigments,
wherein a content of the white pigments in the base layer is 0.25 to 1.5 parts by mass per 100 parts by mass of a solid content of the base layer, and
wherein a mass ratio of the white pigments to the black pigments (white pigments: black pigments) is 0.5:1-1.5:1.
   [5]

The multilayer coating film according to any one of [1] to [4], wherein a color difference ΔE*_{ab} between a color exhibited when the base layer is formed on a substrate layer u1 having a lightness L*45 of 20 to 30 and a color exhibited when the base layer is formed on a substrate layer u2 having a lightness L* of 80 or more, in the base layer, is 3.0 or less.

### Effects of the Invention

The present disclosure provides a multilayer coating film having a hiding property and being capable of exhibiting dichroism due to a difference in light intensity, and preferably to provide a multilayer coating film having a hiding property and being capable of exhibiting dichroism due to a difference in light intensity even if in a solid color.

### DETAILED DESCRIPTION

The multilayer coating film of the present disclosure comprises: an intermediate coating layer; a base layer overlaid on the intermediate coating layer; and a clear layer overlaid on the base layer,
wherein a lightness L*45 is 3 to 10, a degree of yellowness b*45 is −4 or less, and a chroma C*_{ab}45 is 4 to 10, based on a spectral reflectance, when measurement light with a light source 100% is applied,

Wherein a lightness L*45 is 3 or less, a degree of yellowness b*45 is −3 to 0, and a chroma C*_{ab}45 is 3 or less, based on a spectral reflectance, when measurement light with a light source 10% is applied, and wherein a content of a coloring pigment in the base layer is 2.5 parts by mass or more per 100 parts by mass of a solid content of the base layer.

The multilayer coating film of the present disclosure has a hiding property, and exhibits dichroism due to a difference in light intensity, and preferably has a hiding property and exhibits dichroism even in a solid color. The present disclosure should not be construed as being limited to a particular theory, but the reason the multilayer coating film of the present disclosure exhibits such an effect is considered as follows.

That is, the inventors of the present disclosure have found that the multilayer coating film of the present disclosure exhibits a hiding property and dichroism, particularly, exhibits a hiding property and dichroism even in a solid color as a result of restricting the lightness, chroma, and degree of yellowness for measurement light with a prescribed intensity into prescribed ranges and restricting the lightness, chroma, and degree of yellowness for the measurement light with an intensity being 1/10 the aforementioned intensity into prescribed ranges. In a preferred embodiment, the multilayer coating film of the present disclosure is preferably capable of attaining a deep indigo color that looks dark blue when irradiated with strong light such as LED light or sunlight on a sunny day though it looks black at a glance.

In the present disclosure, the phrase “the measurement light is a light source 100%” means that the measurement light is light having an intensity of 100% based on the intensity of the light source, and the light source 10% means that the measurement light is light having an intensity of 10% based on the intensity of the light source.

As the light source, a D65 light source may be used.

In the present disclosure, L*45 means a lightness viewed at 45 degrees, b*45 means a degree of yellowness viewed at 45 degrees, C*_{ab} means a chroma viewed at 45 degrees, and ΔE*_{ab} means a color difference viewed at 45 degrees. “Viewed at 45 degrees” means a value calculated on the basis of the observed light resulting from emission of the measurement light from the normal direction of a surface as a measurement target and subsequent reception at an angle of 45 degrees from the normal direction.

The lightness L*45 based on the spectral reflectance at a light source 100% is 3 to 10, preferably 3 to 8, more preferably 3 to 6, and still more preferably 3.5 to 5.5. A larger lightness L*45 indicates a higher lightness, whereas a smaller lightness L*45 indicates a lower lightness.

The degree of redness a*45 based on the spectral reflectance at a light source 100% is preferably −10 to 10, more preferably −6 to 3, and still more preferably −2 to 2. A larger degree of redness a*45 indicates that redness is stronger, whereas a smaller degree of redness a*45 indicates that greenness is stronger.

The degree of yellowness b*45 based on the spectral reflectance at a light source 100% is −4 or less, preferably −10 to −4, more preferably −8 to −4, and still more preferably −7 or more and −4.5 or less. The larger the degree of yellowness b*45, the stronger the yellowness, whereas the smaller the degree of yellowness b*45, the stronger the blueness.

The chroma C*_{ab}45 based on the spectral reflectance at a light source 100% is 4 to 10, preferably 4 to 9.5, more preferably 4.5 to 9, and still more preferably 5 to 8.5. A larger chroma C*_{ab}45 indicates a higher chroma, whereas a smaller chroma C*_{ab}45 indicates a lower chroma.

The lightness L*45 based on the spectral reflectance at a light source 10% is 3 or less, preferably 0 to 2, more preferably 0 to 1.5, and still more preferably 0 to 1.

The degree of redness a*45 based on a spectral reflectance at a light source 10% is preferably −5 to 5, more preferably −2 to 0.5, and still more preferably −0.1 to 0.3.

The degree of yellowness b*45 based on a spectral reflectance at a light source 10% is −3 to 0 and may be −3 or more and less than 0, and is preferably −2 or more and less than 0, more preferably −1.5 or more and less than 0, and still more preferably −1 or more and less than 0.

The chroma C*_{ab}45 based on a spectral reflectance at a light source 10% is 3 or less and may be more than 0 and 3 or less, and is preferably more than 0 and 2 or less, more preferably more than 0 and 1.5 or less, and still more preferably more than 0 and 1 or less.

The ratio (light source 100%/light source 10%) of the lightness L*45 based on a spectral reflectance at a light source 100% to the lightness L*45 based on a spectral reflectance at a light source 10% is preferably 1 to 18, more preferably 4 to 15, and still more preferably 7 to 12.

The ratio (light source 100%/light source 10%) of the degree of yellowness b*45 based on a spectral reflectance at a light source 100% to the degree of yellowness b*45 based on a spectral reflectance at a light source 10% is preferably 1 to 18, more preferably 4 to 15, and still more preferably 7 to 12.

The ratio (light source 100%/light source 10%) of the chroma C*_{ab}45 based on a spectral reflectance at a light source 100% to the chroma C*_{ab}45 based on a spectral reflectance at a light source 10% is preferably 1 to 18, more preferably 4 to 15, and still more preferably 7 to 12.

In the present disclosure, the lightness L*, the degree of yellowness b*, the chroma C*_{ab}, and the color difference ΔE*_{ab} to be described later are calculated in accordance with JIS Z 8723.

In a preferred embodiment, the multilayer coating film of the present disclosure is used for automobile applications. In such an embodiment, the multilayer coating film of the present disclosure is preferably disposed on an undercoating layer, and the undercoating layer may be disposed on a base material.

The base material may be any material having at least a supporting layer such as a metal layer, a plastic layer, or a foam layer.

Examples of the metal to form the metal layer include iron, copper, aluminum, tin, zinc, and alloys thereof. The metal layer may be in a plate shape and may be a molded article. Specifically, examples of the molded article include bodies, parts, and the like of motorcars such as passenger cars, trucks, motorcycles, and buses.

The metal layer (preferably, on the base layer side of the metal layer) may have been subjected to chemical conversion treatment in advance with a phosphate salt, a zirconium salt, a chromate salt, or the like, and subsequently to formation of an electrodeposition coating film layer as an undercoating layer. Examples of the electrodeposition coating composition which may be used for the formation of an electrodeposition coating film layer include a cationic electrodeposition coating composition and an anionic electrodeposition coating composition.

Examples of the resin to form the plastic layer include polypropylene resin, polycarbonate resin, urethane resin, polyester resin, polystyrene resin, ABS resin, vinyl chloride resin, and polyamide resin. The plastic layer may be in a plate shape or may be a molded article. Examples of the molded article include automobile parts such as spoilers, bumpers, mirror covers, grills, or doorknobs. The plastic layer (preferably on the base layer side of the plastic layer) may have been provided with a primer layer as an undercoating layer.

### (Multilayer Coating Film)

The multilayer coating film of the present disclosure comprises an intermediate coating layer, a base layer overlaid on the intermediate coating layer, and a clear layer overlaid on the base layer.

### (Intermediate Coating Layer)

The intermediate coating layer typically is a layer provided on an undercoating layer. The intermediate coating layer protects the undercoating layer and impart chipping resistance to the multilayer coating film, for example, but the function thereof is not limited thereto.

The intermediate coating film typically comprises a resin.

The resin preferably comprises one or two or more resins selected from among an acrylic resin, a polyol resin, a polyester resin, a polyurethane resin, an epoxy resin, a fluororesin, and a silicone resin, and more preferably comprises one or two or more resins selected from among an acrylic resin, a polyol resin, and a polyester resin.

The intermediate coating layer may comprise a pigment. The pigment preferably comprises one or more pigments selected from an extender pigment and a coloring pigment, and preferably comprises a coloring pigment. As the extender pigment and the coloring pigment, any compound recited as examples of the extender pigment and the coloring pigment in the base layer may be used.

When the intermediate coating layer comprises a pigment, the content of the pigment is preferably 1 to 60 parts by mass, per 100 parts by mass of the solid content of the intermediate coating layer.

In one embodiment, the coloring pigment preferably comprises an achromatic pigment such as carbon black or titanium dioxide, and may comprise a chromatic pigment such as a blue pigment.

The content of a white pigment such as titanium dioxide in the intermediate coating layer is preferably 5 to 20 parts by mass, and more preferably 10 to 15 parts by mass, based on 100 parts by mass of the solid content of the intermediate coating layer. The content of a black pigment such as carbon black in the intermediate coating layer is preferably 1 to 5 parts by mass, and more preferably 2 to 4 parts by mass, per 100 parts by mass of the solid content of the intermediate coating layer. When the contents of the white pigment and the black pigment in the intermediate coating layer are within the above ranges, it is easy to control the lightness of the intermediate coating layer.

The content of the chromatic pigment in the intermediate coating layer is preferably 0 to 2 parts by mass, and more preferably 0 to 1 part by mass, based on 100 parts by mass of the solid content of the intermediate coating layer.

The intermediate coating layer is typically formed from an intermediate coating composition comprising an intermediate coating film forming resin, a coloring pigment, an extender pigment, and the like. As the intermediate coating film forming resin, the compounds recited as examples of the coating film forming resin (A) in a base coating composition described later may be used. As the coating film forming resin used for the intermediate coating composition, a combination of an acrylic resin and/or a polyester resin with an amino resin and/or an isocyanate is preferable from the viewpoint of various performances of the intermediate coating film. As the intermediate coating composition, commercially available products thereof may be used.

The lightness L* of the intermediate coating layer based on a spectral reflectance of a light source 100% is preferably 15 to 35, and more preferably 20 to 30. When the lightness of the intermediate coating layer is within such a range, the lightness and chroma and the hiding property of a resulting multilayer coating film may be improved.

The thickness of the intermediate coating layer is preferably 3 to 50 μm, and more preferably 5 to 30 μm.

### (Base Layer)

The base layer is overlaid on the intermediate coating layer. The base layer may be overlaid in direct contact with the intermediate coating layer, or may be overlaid on the intermediate coating layer with interposition of another layer provided on the intermediate coating layer. The base layer may impart color to the multilayer coating film, for example.

The base layer preferably comprises a resin and a coloring pigment.

The resin used for the base layer preferably comprises one or two or more resins selected from an acrylic resin, a polyol resin, a polyester resin, a polyurethane resin, an epoxy resin, a fluororesin, and a silicone resin; and more preferably comprises one or two or more resins selected from an acrylic resin, a polyol resin, and a polyester resin.

The coloring pigment is not limited as long as it is a pigment that imparts a color, and examples thereof include chromatic pigments and achromatic pigments. The coloring pigment is classified in terms of chemical structure into organic coloring pigments such as azo chelate pigments, azomethine-azo pigments, azo lake pigments, insoluble azo pigments, condensed azo pigments, monoazo pigments, indanthrone pigments, disazo pigments, diketopyrrolopyrrole pigments, benzimidazolone pigments, phthalocyanine pigments, indigo pigments, thioindigo pigments, perinone pigments, perylene pigments, dioxane pigments, quinacridone pigments, quinophthalone pigments, isoindolinone pigments, naphthol pigments, pyrazolone pigments, anthanthrone pigments, anthraquinone pigments, anthrapyrimidine pigments, or metal complex pigments; inorganic coloring pigments such as chrome yellow, iron oxide, yellow iron oxide, transparent iron oxide, iron black, chromium oxide, iron-chromium, bismuth-manganese, bismuth vanadate, chromium oxide, molybdate orange, red iron oxide, titanium yellow, zinc flower, zinc yellow, ocher, carbon black, titanium dioxide, cobalt green, phthalocyanine green, ultramarine, cobalt blue, phthalocyanine blue, or cobalt violet; graphite pigment, and other coloring colored flat pigments.

The coloring pigment preferably comprises a blue pigment. By containing a blue pigment, a blue color tone may be imparted to the multilayer coating film.

As the blue pigment, a pigment having a color tone matching a purpose may be used with appropriate selection from pigments classified into blue, violet, and green in the color index.

The content of the blue pigment in the base layer is preferably 2 to 20 parts by mass, more preferably 3 to 15 parts by mass, and still more preferably 4 to 10 parts by mass, per 100 parts by mass of the solid content of the base layer. When the content of the blue pigment is within the above range, it is easy to exhibit dichroism due to a difference in light intensity.

The coloring pigment preferably further comprises one or more pigments selected from a black pigment and a white pigment. By comprising one or more pigment selected from a black pigment and a white pigment, it is easy to control the lightness of the base layer and to make dichroism to be developed.

Examples of the black pigment include carbon black and perylene black.

The content of the black pigment in the base layer is preferably 0.5 to 2 parts by mass, more preferably 0.7 to 1.8 parts by mass, and still more preferably 0.9 to 1.6 parts by mass, per 100 parts by mass of the solid content of the base layer. When the content of the black pigment is within the above range, the property of hiding a substrate may be improved, and dichroism due to a difference in light intensity is easily exhibited.

In the base layer, the mass ratio of the black pigment to the blue pigment (black pigment: blue pigment) is preferably 1:4-1:15, more preferably 1:5-1:12, and still more preferably 1:6-1:9. When the mass ratio of the black pigment to the blue pigment is within the above range, the property of hiding a substrate may be improved, and dichroism due to a difference in light intensity is easily exhibited.

Examples of the white pigment include silica and titanium oxide.

The content of the white pigment in the base layer is preferably 0.25 to 1.5 parts by mass, more preferably 0.4 to 1.2 parts by mass, and still more preferably 0.65 to 0.9 parts by mass, per 100 parts by mass of the solid content of the base layer. When the content of the white pigment is within the above range, the property of hiding a substrate may be improved, and dichroism due to a difference in light intensity is easily exhibited.

In the base layer, the mass ratio of the white pigment to the black pigment (white pigment: black pigment) is preferably 0.5:1-1.5:1, more preferably 0.6:1-1.2:1, and still more preferably 0.7:1-0.9:1. When the mass ratio of the white pigment to the black pigment is within the above range, the property of hiding a substrate may be improved, and dichroism due to a difference in light intensity is easily exhibited.

In the coloring pigments in the base layer, the total content of the blue pigment, the black pigment, and the white pigment is preferably 80% to 100% by mass, more preferably 90% to 100% by mass, and still more preferably 95% to 100% by mass, in 100% by mass of the total amount of the coloring pigments.

The coloring pigments in the base layer may comprise other coloring pigments in addition to the blue pigment, the black pigment, and the white pigment. Examples of such other coloring pigments include pigments with colors such as yellow, orange, red, brown, and gray.

In the base layer, the total content of the coloring pigments is preferably 2.5 to 30 parts by mass, more preferably 4 to 25 parts by mass, and still more preferably 5 to 20 parts by mass, per 100 parts by mass of the solid content of the base layer.

The base layer may or may not comprise a luster pigment.

Examples of the luster pigment include metallic luster pigments such as aluminum, copper, zinc, iron, nickel, tin, aluminum oxide, and their alloys; mica pigments such as interference mica pigments and white mica pigments; graphite pigments, and glass flake pigments.

The content of the luster pigment in the base layer is preferably 0 to 5 parts by mass, more preferably 0 to 3 parts by mass, and still more preferably 0 to 1 part by mass, per 100 parts by mass of the solid content of the base layer.

In the base layer, a color difference ΔE*_{ab} between a color exhibited when the base layer is formed on a substrate layer u1 having a lightness L*45 of 20 to 30 and a color exhibited when the base layer is formed on a substrate layer u2 having a lightness L* of 80 or more is, preferably 3.0 or less, more preferably 0 to 2, and still more preferably 0 to 1. When the ΔE*_{ab} is within the above range, the hiding property of the base layer is good. The larger the color difference ΔE ab, the larger the difference in color tone, whereas the smaller the color difference, the smaller the difference in color tone.

The thickness of the base layer is, for example, 3 to 50 μm, preferably 5 to 40 μm, and more preferably 5 to 30 μm.

The base layer may be formed using a base coating composition comprising a coating film forming resin (A) and a coloring pigment (C). The base coating composition may further comprise a curing agent (B), as necessary.

### (Coating Film Forming Resin (A))

The coating film forming resin (A) is a resin capable of forming a coating film by reacting with a curing agent (B) described later, and preferably comprises one or two or more resins selected from an acrylic resin, a polyol resin, a polyester resin, a polyurethane resin, an epoxy resin, a fluororesin, and a silicone resin, and more preferably comprises one or two or more resins selected from an acrylic resin, a polyol resin, a polyester resin, and a urethane resin. The coating film forming resin (A) preferably has a hydroxy group.

The coating film forming resin (A) preferably comprises an aqueous resin. The aqueous resin is a resin dispersed in an aqueous medium, and may be an emulsion or a dispersion. Examples of the aqueous resin include an aqueous acrylic resin dispersion, an aqueous polyester resin dispersion, an aqueous urethane resin dispersion, and an aqueous epoxy resin dispersion.

The coating film forming resin (A) preferably comprises an acrylic resin, and more preferably comprises an aqueous acrylic resin dispersion. The aqueous acrylic resin dispersion may be either an acrylic resin emulsion or an acrylic resin dispersion, and is preferably an acrylic resin emulsion. The acrylic resin in the aqueous acrylic resin dispersion may be in the form of particles in an aqueous medium.

Typically, the acrylic resin is obtained as a polymer of a monomer mixture comprising a (meth)acrylic monomer, and the aqueous acrylic resin dispersion is obtained by emulsion-polymerizing the monomer mixture. The monomer mixture preferably comprises a hydroxy group-containing monomer, and may further comprise an acid group-containing monomer and other monomers. In one embodiment, the monomer mixture preferably comprises an alkyl(meth)acrylate, a hydroxy group-containing monomer, and an acid group-containing monomer, and more preferably comprises an alkyl(meth)acrylate, a hydroxy group-containing monomer, an acid group-containing monomer, and a styrene-based monomer.

In the present disclosure, (meth)acrylic acid represents acrylic acid and methacrylic acid.

The alkyl (meth)acrylate is an alkyl (meth)acrylate having no acid group and no hydroxy group. When the monomer mixture contains an alkyl(meth)acrylate, the main backbone of the acrylic resin may be favorably constituted.

Examples of the alkyl (meth)acrylate include methyl(meth)acrylate, ethyl(meth)acrylate, propyl(meth)acrylate, n-butyl(meth)acrylate, isobutyl(meth)acrylate, t-butyl(meth)acrylate, hexyl(meth)acrylate, 2-ethylhexyl(meth)acrylate, octyl(meth)acrylate, nonyl(meth)acrylate, decyl(meth)acrylate, dodecyl(meth)acrylate, and stearyl (meth)acrylate. Alkyl(meth)acrylates may be used singly, or two or more of them may be used in combination.

Examples of the hydroxy group-containing monomer include (meth)acrylic monomers having a hydroxy group, and specifically include hydroxyalkyl (meth)acrylates such as 2-hydroxyethyl(meth)acrylate, 2-hydroxypropyl(meth)acrylate, 4-hydroxybutyl(meth)acrylate, or 2-hydroxybutyl (meth)acrylate; and ¿-caprolactone-modified (meth)acrylic monomers.

As an ε-caprolactone-modified (meth)acrylic monomer, a commercially available product may be used, and examples of the commercially available product comprise PLACCEL FA-1, PLACCEL FA-2, PLACCEL FA-3, PLACCEL FA-4, PLACCEL FA-5, PLACCEL FM-1, PLACCEL FM-2, PLACCEL FM-3, PLACCEL FM-4, and PLACCEL FM-5 (all manufactured by Daicel Chemical Industries, Ltd.). Hydroxy group-containing monomers may be used singly, or two or more of them may be used in combination.

When the monomer mixture contains a hydroxy group-containing monomer, hydrophilicity is imparted to the resulting acrylic resin, and curing reactivity between the acrylic resin and the curing agent (B) described later may be enhanced.

The acid group-containing monomer may be a (meth)acrylic monomer having an acid group, and such an acid group may be a carboxyl group, a sulfonic acid group or a phosphoric acid group, and from the viewpoint of improvement in dispersion stability and the function of accelerating a curing reaction, the acid group is preferably a carboxyl group. When the monomer mixture contains an acid group-containing monomer, various stabilities, such as storage stability, mechanical stability, or stability against freezing, of the resulting acrylic resin may be improved, and a curing reaction between an acrylic resin and a curing agent (B) at the time of coating film formation may be promoted.

Examples of the acid group-containing monomer include carboxyl group-containing monomers such as (meth)acrylic acid, crotonic acid, isocrotonic acid, ethacrylic acid, propylacrylic acid, isopropylacrylic acid, itaconic acid, maleic anhydride, or fumaric acid; sulfonic acid group-containing monomers such as p-vinylbenzenesulfonic acid, p-acrylamidopropanesulfonic acid, or t-butylacrylamidosulfonic acid; and phosphoric acid group-containing monomers such as phosphate monoesters of 2-hydroxyethyl (meth)acrylate or phosphate monoesters of 2-hydroxypropyl (meth)acrylate. Acid group-containing monomers may be used singly, or two or more of them may be used in combination.

Examples of the other monomers include at least one monomer selected from the group consisting of styrene-based monomers, (meth)acrylonitrile, and (meth)acrylamide. Examples of the styrene-based monomers include styrene and α-methylstyrene. Such other monomers may be used singly, or two or more of them may be in combination.

The monomer mixture may further comprise a crosslinkable monomer such as a carbonyl group-containing monomer, a hydrolyzable silyl group-containing monomer, or various polyfunctional vinyl monomers. When the monomer mixture comprises a crosslinkable monomer, self-crosslinkability may be imparted to the resulting acrylic resin. Crosslinkable monomers may be used singly, or two or more of them may be used in combination.

Examples of the carbonyl group-containing monomer include monomers containing a keto group such as acrolein, diacetone (meth)acrylamide, acetoacetoxyethyl(meth)acrylate, formylstyrol, or alkyl vinyl ketones having 4 to 7 carbon atoms (e.g., methyl vinyl ketone, ethyl vinyl ketone, and butyl vinyl ketone).

Examples of the hydrolyzable silyl group-containing monomer include 3-(meth)acryloxypropyltrimethoxysilane, 3-(meth)acryloxypropylmethyldimethoxysilane, and 3-(meth)acryloxypropyltriethoxysilane.

The polyfunctional vinyl monomer is a compound having two or more radically polymerizable, ethylenically unsaturated groups in the molecule. Examples of the polyfunctional vinyl monomer include polyfunctional vinyl compounds such as divinylbenzene, ethylene glycol di(meth)acrylate, hexanediol di(meth)acrylate, polyethylene glycol di(meth)acrylate, allyl(meth)acrylate, 1,4-butanediol di(meth)acrylate, 1,6-hexane di(meth)acrylate, neopentylglycol di(meth)acrylate, and pentaerythritol di(meth)acrylate, and polyfunctional monomers such as triallyl cyanurate, pentaerythritol tri(meth)acrylate, trimethylolpropane tri(meth)acrylate, and dipentaerythritol hexa(meth)acrylate.

Crosslinkable monomers may be used singly, or two or more of them may be used in combination. Examples of preferable crosslinkable monomers include allyl(meth)acrylate, ethylene glycol di(meth)acrylate, and divinylbenzene. Use of such crosslinkable monomers offers an advantage that the average particle size of the acrylic resin in the aqueous acrylic resin dispersion may be suitably controlled to 100 nm or less.

The amount of the crosslinkable monomer is preferably 0.2 to 20% by mass based on the total amount of the monomer mixture, and more preferably 0.5 to 20% by mass. When the monomer mixture contains the crosslinkable monomer within the above range, it offers an advantage that the average particle size of the acrylic resin in the aqueous acrylic resin dispersion to be prepared may be suitably controlled to 100 nm or less.

In the coating film forming resin (A), the acrylic resin in the aqueous acrylic resin dispersion may be in the form of particles, and the average particle size of the particles is preferably 0.01 to 1.0 μm.

In the present disclosure, the average particle size is a volume average particle size determined by a dynamic light scattering method, and specifically, it may be measured using an electrophoretic light scattering photometer ELSZ Series (manufactured by Otsuka Electronics Co., Ltd.) or the like.

In the coating film forming resin (A), the acrylic resin in the aqueous acrylic resin dispersion may be core-shell type particles.

In the coating film forming resin (A), the acid value of the acrylic resin in the aqueous acrylic resin dispersion is preferably 1 to 80 mg KOH/g, more preferably 2 to 70 mg KOH/g, and still more preferably 3 to 60 mg KOH/g.

In the coating film forming resin (A), the hydroxyl value of the acrylic resin in the aqueous acrylic resin dispersion is preferably 30 to 120 mg KOH/g, and more preferably 35 to 100 mg KOH/g. Within the above range, there is an advantage that a curing reaction sufficiently proceeds and a resulting coating film has favorable hardness.

In the present disclosure, the acid value and the hydroxyl value are both values expressed in terms of solid content, and are measured by the methods in accordance with JIS K 0070.

The weight average molecular weight of the acrylic resin in the aqueous acrylic resin dispersion in the coating film forming resin (A) is 50,000 to 5,000,000, and more preferably 50,000 to 1,000,000. Within the above range, a resulting coating film may have various favorable performances such as hardness, adhesion, and water resistance.

In the present disclosure, the weight average molecular weight is a value obtained by converting the measurement result of gel permeation chromatography (GPC) using a polystyrene standard.

Among the solid contents of the coating film forming resin (A), the content of the solid contents of the aqueous acrylic resin dispersion is preferably 30% to 90% by mass, more preferably 40% to 85% by mass, and still more preferably 50% to 80% by mass. Within the above range, there is an advantage that a curing reaction sufficiently proceeds and a resulting coating film has favorable hardness.

The aqueous acrylic resin dispersion may be produced by performing emulsion polymerization of the monomer mixture in an aqueous medium in the presence of a radical polymerization initiator and an emulsifier by heating with stirring. The reaction temperature may be, for example, about 30 to 100° C. The reaction time may be appropriately chosen according to the reaction scale and the reaction temperature, and may be, for example, about 1 to 10 hours. In the emulsion polymerization, for example, the monomer mixture or a monomer pre-emulsion liquid may be added all at once to a reaction vessel charged with water and the emulsifier, or may be dropped for a while. By appropriately selecting such a procedure, the reaction temperature may be adjusted. The monomer pre-emulsion liquid may be prepared by emulsifying the monomer mixture with at least a part of water and an emulsifier.

As the radical polymerization initiator, known initiators used in emulsion polymerization of an acrylic resin may be used. The radical polymerization initiator is preferably a water-soluble radical polymerization initiator and, for example, a persulfate such as potassium persulfate, sodium persulfate, or ammonium persulfate may be used in the form of an aqueous solution. In addition, a so-called redox initiator comprising a combination of an oxidizing agent such as potassium persulfate, sodium persulfate, ammonium persulfate, or hydrogen peroxide and a reducing agent such as sodium bisulfite, sodium thiosulfate, Rongalite, or ascorbic acid may be used in the state of an aqueous solution.

Radical polymerization initiators may be used singly, or two or more of them may be used in combination.

As the emulsifier, an anionic or nonionic emulsifier selected from among micelle compounds each having a hydrocarbon group having 6 or more carbon atoms and a hydrophilic moiety such as a carboxylate, a sulfonate, or a sulfate partial ester, in the same molecule may be used. Examples of the anionic emulsifier include an alkali metal salt or an ammonium salt of a half ester of sulfuric acid with an alkyl phenol or a fatty alcohol; an alkali metal salt or an ammonium salt of an alkyl sulfonate or an allyl sulfonate; an alkali metal salt or an ammonium salt of a half ester of sulfuric acid with a polyoxyethylene alkylphenyl ether, a polyoxyethylene alkyl ether or a polyoxyethylene allyl ether. Examples of the nonionic emulsifier include a polyoxyethylene alkylphenyl ether, a polyoxyethylene alkyl ether, or a polyoxyethylene allyl ether. Other examples of the emulsifier include various anionic or nonionic, reactive emulsifiers each having, in the molecule, a radically polymerizable unsaturated double bond-containing group such as a (meth)acrylic group, a propenyl group, an allyl group, an allyl ether group, or a maleic group.

As the emulsifier, a commercially available product may be used. Examples of the commercially available product include Antox MS-60 (manufactured by Nippon Nyukazai Co., Ltd.), ELEMINOL JS-2 (manufactured by Sanyo Chemical Industries, Ltd.), ADEKA REASOAP SR-10 (manufactured by ADEKA Corporation), and AQUALON HS-10 (manufactured by DKS Co. Ltd.).

Emulsifiers may be used singly, or two or more of them may be used in combination.

In the emulsion polymerization, an auxiliary agent for controlling the molecular weight (chain transfer agent), such as mercaptan compounds or lower alcohols, may be used, if necessary. By use of such an auxiliary agent, emulsion polymerization may be favorably progressed, and the smooth and uniform formation of a coating film may be promoted and the adhesion of a coating film to an article to be coated may be improved.

As the emulsion polymerization, there may be appropriately selected any polymerization method, such as a single-stage continuous uniform dropwise monomer addition method, a core-shell polymerization method that is a multi-stage monomer feeding method, and a power feed polymerization method wherein the constitution of monomers to be fed is continuously altered during polymerization.

At least a part of the acid groups in the acrylic resin may be neutralized by adding a neutralizing agent to the aqueous acrylic resin dispersion obtained. The neutralization may improve the stability of the aqueous acrylic resin dispersion. Examples of the neutralizing agent include basic compounds. Examples of the basic compounds include ammonia; organic amines such as monomethylamine, dimethylamine, trimethylamine, triethylamine, diisopropylamine, monoethanolamine, diethanolamine, or dimethylethanolamine (dimethylaminoethanol), and inorganic bases such as sodium hydroxide, potassium hydroxide, or lithium hydroxide. Neutralizing agents may be used singly, or two or more of them may be used in combination.

In the base coating composition, the content of the solid contents of the aqueous acrylic resin dispersion is preferably 30% to 100% by mass, more preferably 40% to 90% by mass, and still more preferably 50% to 80% by mass, in 100% by mass in total of the solid contents of the coating film forming resin (A).

The polyol resin is a resin having two or more hydroxy groups in the molecule, and examples thereof include polyether polyol and polycarbonate polyol. As the polyol resin, a polyether polyol such as polypropylene glycol is preferable.

The ratio of the primary hydroxyl value to the secondary hydroxyl value (primary/secondary hydroxyl value ratio) in the polyol resin is preferably 10/90 to 90/10, more preferably 40/60 to 80/20, and still more preferably 50/50 to 75/25.

The number average molecular weight of the polyol resin is preferably 300 to 5,000, more preferably 350 to 4,000, and still more preferably 350 to 3,000.

The hydroxyl value of the polyol resin is preferably 30 to 500 mg KOH/g, and more preferably 35 to 300 mg KOH/g.

In the base coating composition, the content of the solid contents of the polyol resin is preferably 1 to 70 parts by mass, more preferably 5 to 50 parts by mass, and still more preferably 10 to 30 parts by mass, per 100 parts by mass of the total amount of the solid contents of the aqueous acrylic resin dispersion.

The polyester resin in the aqueous polyester resin dispersion represents a polymer having a plurality of ester linkages in a main chain, and may be obtained as a reaction product of a polyol and a polycarboxylic acid; an addition polymerization product of a cyclic ester; a reaction product of a reaction product of the polyol and the polycarboxylic acid with a cyclic ester; or the like.

The polyol is a compound having two or more hydroxy groups in one molecule, and examples thereof include aliphatic polyols such as ethylene glycol, diethylene glycol, polyethylene glycol, propylene glycol, dipropylene glycol, polypropylene glycol, 1,2-butanediol, 1,3-butanediol, 2,3-butandiol, 1,4-butanediol, 1,4-pentanediol, neopentyl glycol, and 1,5-hexanediol; alicyclic polyols such as hydrogenated bisphenol A and 1,4-cyclohexanedimethanol; aromatic polyols such as bisphenol A and hydroxyalkylated bisphenol A; tri- or more functional polyols such as glycerin, annitol, trimethylolethane, trimethylolpropane, trimethylolbutane, hexanetriol, pentaerythritol, and dipentaerythritol; tris(hydroxyethyl) isocyanate; and N,N-bis(2-hydroxyethyl)dimethylhydantoin.

The number of the hydroxy groups in one molecule of the polyol is preferably 2 or more, may be 3 or more, and is preferably 6 or less, and more preferably 4 or less.

As the polyol, one polyol may be used, or two or more polyols may be used in combination.

The polycarboxylic acid means a compound having two or more carboxy groups in one molecule. Examples of the polycarboxylic acid include aromatic polycarboxylic acids such as phthalic acid, isophthalic acid, terephthalic acid, trimellitic acid, and pyromellitic acid; alicyclic polycarboxylic acids such as tetrahydrophthalic acid, hexahydrophthalic acid, methyltetrahydrophthalic acid, cyclohexane-1,4-dicarboxylic acid, 5-norbornene-2,3-dicarboxylic acid, and methyl-5-norbornene-2,3-dicarboxylic acid; aliphatic polycarboxylic acids such as maleic acid, fumaric acid, itaconic acid, adipic acid, azelaic acid, sebacic acid, succinic acid, and dodecenylsuccinic acid; hydroxy acids such as lactic acid; and anhydrides of the aromatic polycarboxylic acids, the alicyclic polycarboxylic acids, and the aliphatic polycarboxylic acids. As the polycarboxylic acid, one polycarboxylic acid may be used, or two or more polycarboxylic acids may be used in combination.

Examples of the cyclic ester include ε-caprolactone.

The polyester resin comprises a modified product of the polyester resin described above as well. The modification of the resin may be performed by reacting a modifier with the terminal of the main chain constituting the resin. Examples of the modifier include compounds having a reactive group such as an isocyanate group, a hydroxy group, or a carboxy group, and a compound having a silicone skeleton. Examples of the modified products of the polyester resin include urethane-modified polyester resins, epoxy-modified polyester resins, acrylic-modified polyester resins, and silicone-modified polyester resins.

In the base coating composition, the content of the solid contents of the aqueous polyester resin dispersion is preferably 1 to 50 parts by mass, more preferably 5 to 40 parts by mass, and still more preferably 10 to 30 parts by mass, per 100 parts by mass of the total amount of the solid contents of the aqueous acrylic resin dispersion.

Examples of the urethane resin in the aqueous urethane resin dispersion include a reaction product of a polyol with a polyisocyanate; and a reaction product of that reaction product with a chain extender to be used as necessary.

The polyol means a compound having two or more hydroxy groups in one molecule. Examples of the polyol include aliphatic polyols such as ethylene glycol, diethylene glycol, polyethylene glycol, propylene glycol, dipropylene glycol, polypropylene glycol, 1,2-butanediol, 1,3-butanediol, 2,3-butanediol, 1,4-butanediol, 1,4-pentanediol, neopentyl glycol, 1,5-hexanediol, and 1,6-hexanediol; alicyclic polyols such as hydrogenated bisphenol A and 1,4-cyclohexanedimethanol; aromatic polyols such as bisphenol A, hydroxyalkylated bisphenol A (especially, bisphenol hydroxypropyl ether); tri- or more functional polyols such as glycerin, annitol, trimethylolethane, trimethylolpropane, trimethylolbutane, hexanetriol, pentaerythritol, and dipentaerythritol; and high molecular weight polyols (for example, polyols having a weight average molecular weight of 800 or more) such as polyether polyol, acrylic polyol, polyurethane polyol, polyester polyol, polyester amide polyol, and polycarbonate polyol.

As the polyol, one polyol may be used, or two or more polyols may be used in combination.

The number of the hydroxy groups in the polyol is 2 or more, may be 3 or more, and is preferably 6 or less, and more preferably 4 or less.

The polyisocyanate means a compound having two or more isocyanate groups in one molecule. Examples of the polyisocyanate include aliphatic polyisocyanates such as trimethylene diisocyanate, tetramethylene diisocyanate, pentamethylene diisocyanate, and hexamethylene diisocyanate; alicyclic polyisocyanates such as 1,3-cyclopentane diisocyanate, 1,4-dicyclohexylmethane diisocyanate, 1,2-cyclohexane diisocyanate, isophorone diisocyanate, norbornane diisocyanate methyl, and hydrogenated xylylene diisocyanate; aromatic isocyanates such as 1,4-tolylene diisocyanate, 1,6-tolylene diisocyanate, xylylene diisocyanate, diphenylmethane diisocyanate, meta-xylylene diisocyanate, naphthylene diisocyanate, and 3,3′-dimethyl-4,4′-biphenylene diisocyanate; and multimers, such as burette forms, isocyanurate forms, and uretdione forms, and allophanate forms, of the aliphatic polyisocyanates, alicyclic diisocyanates, and aromatic polyisocyanates. As the polyisocyanate, one polyisocyanate may be used, or two or more polyisocyanates may be used in combination.

The chain extender means a compound having one or more active hydrogen atoms in one molecule, and water or an amine compound may be used. Examples of the amine compound such as ethylenediamine, propylenediamine, hexamethylenediamine, diethylenetriamine, dipropylenetriamine, triethylenetetramine, and tetraethylenepentamine; aromatic polyamines such as tolylenediamine, xylylenediamine, and diaminodiphenylmethane; alicyclic polyamines such as diaminocyclohexylmethane, piperazine, 2,5-dimethylpiperazine, and isophoronediamine; hydrazine compounds such as hydrazine, succinic dihydrazide, adipic dihydrazide, and phthalic dihydrazide; and alkanolamines such as hydroxyethyldiethylenetriamine, 2-[(2-aminoethyl)amino]ethanol, and 3-aminopropanediol.

In one embodiment, ester-based urethane resins, ether-based urethane resins, and carbonate-based urethane resins may be used as the urethane resin.

In the base coating composition, the content of the solid contents in the aqueous urethane resin dispersion may be preferably 1 to 50 parts by mass, more preferably 5 to 40 parts by mass, and still more preferably 10 to 30 parts by mass, per 100 parts by mass of the total amount of the solid contents of the aqueous acrylic resin dispersion.

The hydroxyl value of the coating film forming resin (A) is preferably 30 to 120 mg KOH/g, and more preferably 35 to 100 mg KOH/g. Within the above range, there is an advantage that a curing reaction sufficiently proceeds and a resulting coating film has favorable hardness.

The content of the solid contents of the coating film forming resin (A) may be preferably 10% to 90% by mass, more preferably 15% to 85% by mass, and still more preferably 20% to 80% by mass, based on 100% by mass of the solid content of the base coating composition.

In the present disclosure, the “solid content” of an ingredient means a heating residue after the ingredient is heated at 105° C. for 3 hours.

### (Curing Agent (B))

The curing agent (B) may be a compound having, in one molecule, two or more groups capable of reacting with the coating film forming resin (A), and corresponds to a coating film forming component together with the coating film forming resin (A). As the curing agent (B), one or two or more selected from among an amino resin (melamine resin, urea resin, benzoguanamine resin, or the like), a blocked isocyanate compound, an epoxy compound, an aziridine compound, a carbodiimide compound, an oxazoline compound, and a metal ion may be used.

In one embodiment, the curing agent (B) preferably comprises an amino resin, and more preferably comprises a melamine resin. When a melamine resin is included, a coating film may be formed through self-polymerization of the melamine resin and a reaction of amino groups in the melamine resin with hydroxy groups in the coating film forming resin (A).

The melamine resin is obtained by modifying a condensate of an amino compound such as melamine and an aldehyde compound such as formaldehyde or acetaldehyde with a lower alcohol such as methanol, ethanol, propanol, or butanol. The melamine resin is preferably a compound having three reactive functional groups represented by the following formula as reactive functional groups in one molecule of triazine nucleus, or a polycondensate thereof,

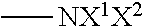

wherein X¹ and X² each independently represent a hydrogen atom, a methylol group, or —CH₂—OR¹;
R¹ represents an alkyl group having 1 to 8 carbon atoms, preferably a linear or branched alkyl group having 1 to 8 carbon atoms; and
when a plurality of —CH₂—OR¹ is in the same molecule, a plurality of R's may be the same or different.

Examples of the melamine resin include the following four types: a full alkyl type comprising only —N(CH₂OR¹) 2 as reactive functional; a methylol group type comprising —N(CH₂OR¹)(CH₂OH) as a reactive functional group; an imino group type comprising —N(CH₂OR¹)(H) as a reactive functional group; and a methylol/imino group type comprising —N(CH₂OR¹)(CH₂OH) and —N(CH₂OR¹)(H) or comprising-N(CH₂OH)(H) as reactive functional groups. In the full alkyl type, methylol group type, imino group type, or methylol/imino group type melamine resin, R¹ is preferably an alkyl group having 1 to 4 carbon atoms, and is preferably a methyl group, an n-butyl group, or an isobutyl group. In one embodiment, R¹ may be a mixture of a methyl group and a butyl group, in another embodiment, R¹ may be only a methyl group, and in still another embodiment, R¹ may be only a butyl group.

As the melamine resin, a commercially available product may be used. Examples of the commercially available product include a methylol group-imino type methyl/butyl mixed etherified melamine resin such as CYMEL 202; imino-type methyl/butyl mixed etherified melamine resins such as CYMEL 204, CYMEL 211, CYMEL 250, CYMEL 254, MYCOAT 212, MYCOAT 518, and MYCOAT 525; fully alkyl type methylated melamine resins such as CYMEL 350; imino group type methylated melamine resins such as CYMEL 325, CYMEL 327, CYMEL 385, CYMEL 701, CYMEL 712, MYCOAT 723, and MYCOAT 776; imino group type butylated melamine resins such as MYCOAT 508; methylol group type methylated melamine resins such as CYMEL 370; and methylol group type methyl/isobutyl mixed etherified melamine resins such as MYCOAT 2677 (all manufactured by Allnex Japan Inc.).

The solid content of the melamine resin may be 0% by mass, and is preferably 80% to 100% by mass, more preferably 90% to 100% by mass, and still more preferably 95% to 100% by mass in 100% by mass of the total solid content of the curing agent (B).

The content of the melamine resin may be 0 parts by mass, or may be preferably 10 to 90 parts by mass, or 20 to 80 parts by mass, in 100 parts by mass of the sum total of the solid content of the coating film forming resin (A) and the solid content of the curing agent (B). This may result in an advantage that a resulting coating film may have various favorable properties such as hardness, adhesion, and water resistance.

The blocked isocyanate compound may be prepared by adding a blocking agent having an active hydrogen to polyisocyanate such as trimethylene diisocyanate, hexamethylene diisocyanate, xylylene diisocyanate, or isophorone diisocyanate. Such a blocked isocyanate resin, upon heating, dissociates a blocking agent and generates an isocyanate group and this group reacts with a functional group in a resin component to cure the resin.

The content of the solid content of the curing agent (B) in the aqueous base coating composition is preferably 20% to 50% by mass, and more preferably 20% to 40% by mass, in 100% by mass of the sum total of the solid content of the coating film forming resin (A) and the solid content of the curing agent (B).

### (Coloring Pigment (C))

The coloring pigment has the same meaning as described above, and may impart a color to the base layer. The coloring pigment may have either a chromatic color or an achromatic color, and may have a color such as red, blue, yellow, green, purple, brown, white, black, or gray.

The coloring pigment (C) preferably comprises a blue pigment. By comprising a blue pigment, a blue color tone may be imparted to the multilayer coating film. The blue pigment has the same meaning as described above.

The content of the blue pigment in the base coating composition is preferably 2 to 20 parts by mass, more preferably 3 to 15 parts by mass, and still more preferably 4 to 10 parts by mass, per 100 parts by mass of the solid content of the base coating composition. When the content of the blue pigment is within the above range, it is easy to exhibit dichroism due to a difference in light intensity.

In the present disclosure, the solid content of the base coating composition corresponds to the solid content of the component forming a coating film. For example, when the coating film forming resin (A) is contained, and neither the curing agent (B) nor additives (other components) is contained, the solid content means the total solid content of the coating film forming resin (A) and the coloring pigment; when the coating film forming resin (A) and the curing agent (B) are contained, and additives (other components) are not contained, the solid content means the total solid content of the coating film forming resin (A), the curing agent (B), and the coloring pigment; and when the coating film forming resin (A), the curing agent (B), and additives (other components) are contained, the solid content means the total solid content of the coating film forming resin (A), the curing agent (B), the coloring pigment, and the additives (other components).

The coloring pigment (C) preferably comprises one or more pigment selected from a black pigment and a white pigment. By comprising one or more pigment selected from a black pigment and a white pigment, it is easy to control the lightness of the base layer and to make dichroism to be developed. The black pigment and the white pigment each have the same meaning as described above.

The content of the black pigment in the base coating composition is preferably 0.5 to 2 parts by mass, more preferably 0.7 to 1.8 parts by mass, and still more preferably 0.9 to 1.6 parts by mass, per 100 parts by mass of the solid content of the base coating composition. When the content of the black pigment is within the above range, the property of hiding a substrate may be improved, and dichroism due to a difference in light intensity is easily exhibited.

In the base coating composition, the mass ratio of the black pigment to the blue pigment (black pigment: blue pigment) is preferably 1:4-1:15, more preferably 1:5-1:12, and still more preferably 1:6-1:9. When the mass ratio of the black pigment to the blue pigment is within the above range, the property of hiding a substrate may be improved, and dichroism due to a difference in light intensity is easily exhibited.

The content of the white pigment in the base coating composition is preferably 0.25 to 1.5 parts by mass, more preferably 0.4 to 1.2 parts by mass, and still more preferably 0.65 to 0.9 parts by mass, per 100 parts by mass of the solid content of the base coating composition. When the content of the white pigment is within the above range, the property of hiding a substrate may be improved, and dichroism due to a difference in light intensity is easily exhibited.

In the base coating composition, the mass ratio of the white pigment to the black pigment (white pigment: black pigment) is preferably 0.5:1-1.5:1, more preferably 0.6:1-1.2:1, and still more preferably 0.7:1-0.9:1. When the mass ratio of the white pigment to the black pigment is within the above range, the property of hiding a substrate may be improved, and dichroism due to a difference in light intensity is easily exhibited.

In the coloring pigment (C), the total content of the blue pigment, the black pigment, and the white pigment is preferably 80% to 100% by mass, more preferably 90% to 100% by mass, and still more preferably 95% to 100% by mass, in 100% by mass of the total amount of the coloring pigment (C).

The coloring pigment (C) may comprise other coloring pigments in addition to the blue pigment, the black pigment, and the white pigment. Examples of such other coloring pigments include pigments with colors such as yellow, orange, red, brown, and gray.

In the base coating composition, the total content of the coloring pigment (C) is preferably 2.5 to 30 parts by mass, more preferably 4 to 25 parts by mass, and still more preferably 5 to 20 parts by mass, per 100 parts by mass of the solid content of the base coating composition.

The base coating composition may or may not comprise a luster pigment. The luster pigment has the same meaning as described above.

The content of the luster pigment in the base coating composition is preferably 0 to 5 parts by mass, more preferably 0 to 3 parts by mass, and still more preferably 0 to 1 part by mass, per 100 parts by mass of the solid content of the base coating composition.

The coloring pigment (C) and the luster pigment used as necessary may be used in the preparation of the base coating composition in the form of a pigment dispersion paste prepared in advance. The pigment dispersion paste is obtained by dispersing a pigment, a pigment dispersant, and a part of a coating film forming resin (A) to be used as necessary in a small amount of an aqueous medium in advance. The pigment dispersant may be a resin having a structure comprising a pigment-affinitive part and a hydrophilic part. Examples of the pigment-affinitive part and the hydrophilic part include nonionic, cationic, and anionic functional groups. The pigment dispersant may have two or more types of the above-mentioned functional groups in one molecule.

Examples of the nonionic functional group include a hydroxy group, an amide group, and a polyoxyalkylene group. Examples of the cationic functional group include an amino group, an imino group, and a hydrazino group. Examples of the anionic functional group include a carboxyl group, a sulfone group, and a phosphoric acid group. Such pigment dispersants may be produced by methods well known to those skilled in the art.

The pigment dispersant is not particularly limited as long as it does not comprise any volatile basic substance in its solid content or contains a volatile basic substance in a content of 3% by mass or less, preferred is a pigment dispersant capable of dispersing a pigment efficiently by a small amount of the pigment dispersant. As the pigment dispersant, a commercially available product may be used. Examples of the commercially available product include Disperbyk-180, Disperbyk-190 (both manufactured by BYK-Chemie GmbH), EFKAPOLYMER 4550 (manufactured by BASF), and EFKAPOLYMER 4585 (manufactured by BASF), which are anion-nonionic dispersants, Solsperse 27000 (manufactured by Avecia), which is a nonionic dispersant, Solsperse 41000 and Solsperse 53095 (both manufactured by Avecia), which are anionic dispersants, and Disperbyk-2015 as a copolymer (manufactured by BYK-Chemie GmbH).

The weight average molecular weight of the pigment dispersant is preferably 1,000 to 100,000, more preferably 2,000 to 100,000, and still more preferably 4,000 to 50,000.

The pigment dispersion paste may be prepared by mixing and dispersing a pigment dispersant, a pigment, and a part of a coating film forming resin (A) to be used as necessary in accordance with a known method. The proportion of the pigment dispersant during the production of the pigment dispersion paste is preferably 1% to 50% by mass, based on the solid content of the pigment dispersion paste. When the proportion of the pigment dispersant is within the above range, pigment dispersion stability and the physical properties of a resulting coating film may be held in favorable ranges. The proportion of the pigment dispersant is more preferably 3% by mass or more, and more preferably 5% by mass or less.

The base coating composition preferably comprises an aqueous medium.

The aqueous medium in the present disclosure may be water; hydrophilic solvent; or a mixture of water and a hydrophilic solvent. Examples of the hydrophilic solvent include glycol-based solvents such as ethylene glycol, propylene glycol, butanediol, diethylene glycol, dipropylene glycol, and triethylene glycol; glycol ether-based solvents such as ethylene glycol monobutyl ether (butyl cellosolve), diethylene glycol monobutyl ether, triethylene glycol monoethyl ether, propylene glycol monomethyl ether, propylene glycol monoethyl ether, propylene glycol monopropyl ether, dipropylene glycol monomethyl ether, and dipropylene glycol monoethyl ether; alcohol-based solvents such as methanol, ethanol, isopropyl alcohol, and benzyl alcohol; cyclic ether-based solvents such as dioxane and tetrahydrofuran; ketone-based solvents such as acetone; and N-methyl-2-pyrrolidone.

### (Other Components)

The base coating composition may comprise, in addition to the components described above, an additive commonly used by those skilled in the art as long as this does not affect coating film performance and coating film appearance. Examples of the additives include pigments such as an extender pigment, a coloring pigment, and a rust preventive pigment; an anti-sagging and anti-settling agent; a curing catalyst (organometallic catalyst); a color separation inhibitor; a dispersant; an antifoaming/anti-bubbling agent; a surface conditioning agent; a viscosity modifier; a viscosity control agent; a leveling agent; a matting agent; an antioxidant; an ultraviolet ray inhibitor; a plasticizer; a film formation aid; an antifoaming agent; and a phosphate group-containing organic compound.

Examples of the extender pigment include titanium oxide, calcium carbonate, barium sulfate, barium carbonate, magnesium silicate, clay, talc, silica, and calcined kaolin.

### (Viscosity Modifier)

The base coating composition of the present disclosure preferably comprises a viscosity modifier. When the base coating composition comprises the viscosity modifier, thixotropy is imparted to the base coating composition, application workability is improved, and the appearance of a resulting multilayer coating film may be improved.

Viscosity modifiers comprise organic viscosity modifiers and inorganic viscosity modifiers, and examples of the organic viscosity modifiers comprise crosslinked or non-crosslinked resin particles; polyamide-based viscosity modifiers such as a swelling dispersion of an aliphatic acid amide, amide-based fatty acids, and phosphate salts of long-chain polyaminoamides; and polyethylene-based viscosity modifiers such as a colloidal swelling dispersion of polyethylene oxide. Examples of the inorganic viscosity modifiers include organic bentonite-based viscosity modifiers such as organic acid smectite clay and montmorillonite.

Examples of the viscosity control agent include a nonionic associated urethane viscosity control agent, an alkali-swollen viscosity control agent, and bentonite, which is an inorganic intercalation compound.

In the base coating composition, the solid concentration (the total content of solid components) is 15% to 40% by mass, preferably 18% to 35% by mass, and more preferably 20% to 30% by mass.

The base coating composition may be produced by a method usually used by those skilled in the art, such as kneading and dispersing a coating film forming resin (A) and a coloring pigment (C), and a curing agent (B), other components, additives, and so on to be used as necessary by use of a disperser, a homogenizer, a kneader, or the like.

### (Clear Layer)

The clear layer is preferably disposed on the base layer. When the clear layer is included, irregularities or the like caused by a base coating film may be smoothened, the base coating film may be protected, and may be provided with an aesthetic appearance.

The clear layer may be formed of a clear coating composition. As the clear coating composition, a clear coating composition comprising a coating film forming resin, a curing agent, and the like may be used. Further, the clear coating composition may further comprise a coloring component as long as the designability of a substrate is not impaired. In addition, the clear coating composition may comprise a matting agent to afford a coating film having a desired gloss (gloss value; for example, from full gloss to full matte). Examples of the form of the clear coating composition include solvent type, aqueous type, and powder type.

From the viewpoint of transparency or resistance to acid etching, preferable examples of the solvent-type clear coating composition include a combination of an acrylic resin and/or a polyester resin with an amino resin and/or an isocyanate, or an acrylic resin and/or a polyester resin with a carboxylic acid/epoxy curing system.

Examples of the aqueous-type clear coating composition include a composition comprising the coating film forming resin in a coating composition disclosed above as an example of the solvent-type clear coating composition, the coating film forming resin having been hydrophilized by being neutralized with a base. The neutralization may be carried out, before or after polymerization, by adding a tertiary amine such as dimethylethanolamine or triethylamine.

The powder-type clear coating composition may be obtained using a common powder coating material such as a thermoplastic or thermally curable powder coating material. A thermally curable powder coating material is preferable because a coating film having good physical properties may be obtained therefrom. Examples of the thermally curable powder coating material specifically include epoxy-based, acrylic-based and polyester-based powder clear coating compositions, and acrylic-based powder clear coating compositions, which have good weatherability, are particularly preferable.

The clear coating composition preferably comprises a viscosity controlling agent added to ensure coating workability. As the viscosity controlling agent, one that exhibits a thixotropic property may be commonly used. For example, one conventionally known may be used as such a material. The clear coating composition may comprise a curing catalyst, a surface conditioning agent, and so on, as necessary.

As the clear coating composition, commercially available products thereof may be used.

The thickness of the clear layer may be preferably 15 to 40 μm, and more preferably 20 to 30 μm.

### (Method for Producing Multilayer Coating Film)

The multilayer coating film of the present disclosure may be produced, for example, by a method comprising:
a step of forming an intermediate coating layer by applying an intermediate coating composition onto an article to be coated;
a step of forming a base layer by applying a base coating composition onto the intermediate coating layer; and
a step of forming a clear layer by applying a clear coating composition onto the base layer.

As the article to be coated, various base materials such as a metal shaped article, a plastic shaped article, or a foamed article may be used. The aqueous base coating compositions of the present disclosure may be suitably used in the coating of automobile exterior panels such as automobile bodies and automobile parts. Examples of the metal molded article include plates and molded articles of iron, copper, aluminum, tin, zinc, and the like, and alloys comprising these metals, and specifically include bodies and parts of motorcars such as automobiles, trucks, motorcycles, and buses.

The metal molded article may have been subjected to chemical conversion treatment in advance with a phosphate salt, a zirconium salt, a chromate salt, or the like, and subsequent formation of an electrodeposition coating film as an undercoating layer. Examples of the electrodeposition coating composition which may be used for the formation of an electrodeposition coating film include a cationic electrodeposition coating composition and an anionic electrodeposition coating composition.

Examples of the plastic molded article include plates and molded articles of polypropylene resin, polycarbonate resin, urethane resin, polyester resin, polystyrene resin, ABS resin, vinyl chloride resin, and polyamide resin. Examples of the plastic molded articles include automobile parts such as spoilers, bumpers, mirror covers, grills, or doorknobs. These plastic molded articles may have been provided with primer coating for enabling electrostatic coating as an undercoating layer.

The intermediate coating layer may be formed typically by applying the intermediate coating composition to form an intermediate coating film, and heating and curing the intermediate coating film.

The heating temperature and time in the case of heating and curing the intermediate coating film may be appropriately chosen according to the composition (aqueous or solvent-type) of the coating composition and the type of the article to be coated. The heating temperature may be appropriately chosen, for example, in the range of 80 to 180° C., preferably in the range of 100 to 160° C. The heating time may be appropriately chosen, for example, in the range of 5 minutes to 60 minutes, preferably 10 minutes to 30 minutes.

The temperature at the time of preheating the intermediate coating film may be, for example, 30 to 80° C., and the preheating time may be, for example, 1 minute to 60 minutes.

The base coating composition may be applied to an article to be coated by techniques commonly used in the coating material field. Examples of an application method include multistage application, preferably two-stage application, using air-spray application, airless-spray application, electrostatic spray application, or air-electrostatic spray application, or application combining air-electrostatic spray application and a rotary atomization type electrostatic applicator.

The heating temperature and time in the case of heating and curing the base coating composition may be appropriately chosen according to the composition (aqueous or solvent-type) of the coating compositions and the type of the article to be coated. The heating temperature may be appropriately chosen, for example, in the range of 80 to 180° C., preferably in the range of 100 to 160° C. The heating time may be appropriately chosen, for example, in the range of 5 minutes to 60 minutes, preferably 10 minutes to 30 minutes.

The base coating film is preferably applied such that the dry film thickness is 8 to 20 μm, and is more preferably applied such that the dry film thickness is 10 to 15 μm.

Example of the method for applying a clear coating material include an application method using a rotary atomizing electrostatic coating machine called micro micro bell or micro bell.

When the clear coating material is applied and then heated and cured, the heating and curing temperature is preferably 80 to 180° C., and more preferably 120 to 160° C. from the viewpoint of curability and physical properties of the resulting multilayer coating film. The heating and curing time may be arbitrarily set according to the heating and curing temperature described above, and it is preferable that the heating and curing temperature is 80° C. to 180° C. and the heating and curing time is 10 to 30 minutes.

In the production method described above, a base coating film and a clear coating film may be produced by applying a base coating composition, then wet-on-wet applying a clear coating composition on the uncured base coating film without heating and curing the uncured base coating film, thereby forming an uncured clear coating film, and then heating and curing the uncured base coating film and the uncured clear coating film simultaneously. The wet-on-wet application may make the surface of the multilayer coating film smoother.

When the base coating composition and the clear coating composition are applied wet-on-wet, the uncured base coating film may be preheated before applying the clear coating composition. The temperature at the time of preheating the base coating film may be, for example, 30 to 80° C., and the preheating time may be, for example, 1 minute to 60 minutes.

The multilayer coating film of the present disclosure has a hiding property, and may exhibit dichroism due to a difference in light intensity, and preferably has a hiding property and may exhibit dichroism due to light intensity even in a solid color. Therefore, the multilayer coating film of the present disclosure is preferably used for coating automobile bodies and the like.

### Examples

The present invention will be described more specifically with reference to the following examples, but the present invention is not limited to the examples.

### Examples 1 to 9, Comparative Examples 1 to 8

### (I) Preparation of Article to be Coated

A zinc phosphate-treated steel sheet with a cured electrodeposition coating film was prepared as an article to be coated. The cured electrodeposition coating film was formed by electrodeposition coating the zinc phosphate-treated steel sheet with “POWERNICS”, which is a cationic electrodeposition coating composition manufactured by Nippon Paint Automotive Coatings Co., Ltd., such that a dry film thickness was 20 μm, and then heating at 160° C. for 30 minutes.

### (II-1) Preparation of Intermediate Coating Material

As intermediate coating materials, two types of intermediate coating compositions (trade name: OP-30-P dark gray 8110, manufactured by Nippon Paint Automotive Coatings Co., Ltd.) and (trade name: OP-30-P 8005, manufactured by Nippon Paint Automotive Coatings Co., Ltd.) were prepared.

### (II-2) Preparation of Base Coating Composition

A base coating composition including the following ingredients was prepared using the following for the preparation of the base coating composition. In the base coating composition, the sum total of the solid mass of the coating film forming resin and the solid mass of the curing agent (the solid content amount of the main resin) was 100 parts by mass.

### Coating Film Forming Resin (A)

(A1) 236 parts by mass of an acrylic emulsion resin (average particle size: 150 nm, nonvolatile content: 20%, solid acid value: 20 mg KOH/g, solid hydroxyl value: 40 mg KOH/g) produced by Nippon Paint Co., Ltd.
(A2) 10 parts by mass of a 10% by mass aqueous dimethylethanolamine solution
(A3) 28.3 parts by mass of water-soluble acrylic resin (nonvolatile content: 30% by mass, solid acid value: 40 mg KOH/g, solid hydroxyl value: 50 mg KOH/g) produced by Nippon

### Paint Co., Ltd.

(A4) 8.6 parts by mass of “PRIMEPOL PX-1000” (bifunctional polyether polyol, number average molecular weight: 400, solid hydroxyl value: 278 mg KOH/g, primary/secondary hydroxyl value ratio=63/37, nonvolatile content: 100% by mass) produced by Sanyo Chemical Industries, Ltd.
(A5) 26 parts by mass of “NeoRez R-9603” (polycarbonate-based urethane emulsion resin, nonvolatile content: 33% by mass) produced by Avecia

### Curing Agent (B)

(B1) 21.5 parts by mass of “CYMEL 204” (mixed alkylated melamine resin, nonvolatile content: 100% by mass) produced by Mitsui Chemicals, Inc.

### Other Additives (D)

(D1) 0.2 parts by mass of phosphoric acid group-containing organic compound (lauryl acid phosphate)

### Solvent (E)

(E1) 10 parts by mass of 2-ethylhexanol
(E2) 25 parts by mass of mono 2-ethylhexyl ether

A coloring pigment (C) shown below was added to the base coating composition in the content (PWC) shown in Table 1, affording an aqueous coating composition.

### Coloring Pigment (C)

(C1) Black pigment (carbon black, Raven 5000 Ultra III Powder (manufactured by Birla)
(C2) Blue pigment (Cyanine Blue, Cyanine Blue G-314R (manufactured by Sanyo Color Works, Ltd.))
(C3) Blue pigment (Threne Blue, Lionogen Blue 6520 (manufactured by Toyocolor Co., Ltd.))
(C4) White pigment (titanium oxide, Tipaque CR-97 (manufactured by Ishihara Sangyo Kaisha, Ltd.))
(C5) Red pigment (quinacridone red, FASTOGEN SUPER RED 400RG (manufactured by DIC Corporation))

The mass concentration of a pigment was calculated by:

$$mass concentration ( PWC ) of pigment = ( mass of pigment ) / [ ( total mass of solid content of coating film forming resin , solid content of curing agent , and solid content of additives ) + ( total mass of pigment ) ] \times 100 ( \% by mass ) .$$

### (II-3) Preparation of Clear Coating Material

As a clear coating material, an acid epoxy curable clear coating material (trade name: MACFLOW O-1820 Clear, manufactured by Nippon Paint Automotive Coatings Co., Ltd.) was prepared.

### (III) Formation of Coating Film

An intermediate coating material (diluted in advance to 25 seconds (measured at 20° C. using No. 4 Ford cup)) was applied to an article to be coated, by air-spray coating using an air spray gun W-101-132G manufactured by ANEST IWATA Corporation such that a dry film thickness of 35 μm was attained. The coated plate was heated at 140° C. for 30 minutes with a dryer, affording a coated film article with an intermediate coating layer.

Subsequently, the base coating material was air-spray applied under conditions of a room temperature of 23° C. and a humidity of 68% such that a dry film thickness of 15 μm was attained. After setting for 3 minutes, preheating was performed at 80° C. for 4 minutes. The coated plate was allowed to cool to room temperature, and a clear coating material was air-spray applied such that a dry film thickness of 30 μm was attained, followed by setting for 7 minutes. The coated plate was heated at 140° C. for 30 minutes with a dryer, affording a coated article.

### (IV) Evaluation

Each of the coated articles was subjected to the following evaluations using a spectrophotometer (BYK-mac i manufactured by BYK Gardner). The results of the evaluations are shown in the following tables.

### (1) Lightness L*45

The L*45 of the coated article was acquired using a spectrophotometer (BYK-mac i manufactured by BYK Gardner).

(2) Angle a*45 Indicating the Green-Red Chroma (Degree of Redness)

The a*45 of the coated article was acquired using a spectrophotometer (BYK-mac i manufactured by BYK Gardner).

(3) Angle b*45 Indicating the Blue-Yellow Chroma (Degree of Yellowness)

The b*45 of the coated article was acquired using a spectrophotometer (BYK-mac i manufactured by BYK Gardner).

### (4) Chroma C*_{ab}45

The chroma C*_{ab}45 of the coated article was acquired using a spectrophotometer (BYK-mac i manufactured by BYK Gardner).

The results of evaluations (1) to (4) are taken as numerical values of a light source 100%.

(5) L*45, a*45, b*45, C*_{ab}45 with a Light Source 10%

Using a spectrophotometer (BYK-mac i manufactured by BYK Gardner), the spectral reflectance of the coated article with D65 as a light source was measured, and numerical values at a light source 10% were acquired by converting that measured value multiplied by 1/10 into L*45, a*45, b*45, and C*_{ab}45 by a method in accordance with JIS Z 8781-4.

### (6) Hiding Property (Color Stability at the Time of Substrate Change)

The same coating material of each of Examples and Comparative Examples was applied onto the intermediate coating materials differing in lightness (OP-30-P dark gray 8110 and OP-30-P 8005), and a color difference ΔE*_{ab}45 between the coated plates was acquired using a spectrophotometer (BYK-mac i manufactured by BYK Gardner).

TABLE 1

| | | | | Example 1 | Example 2 | Example 3 | Example 4 | Example 5 |
|---|---|---|---|---|---|---|---|---|
| Base | Coloring | (C1) | parts by | 1.0 | 1.0 | 1.0 | 1.0 | 1.0 |
| | pigment | | mass | | | | | |
| | | (C2) | parts by | 5.0 | 7.0 | 3.0 | 10.0 | 5.0 |
| | | | mass | | | | | |
| | | (C3) | parts by | 2.5 | 0.8 | 4.5 | 5.0 | 0.0 |
| | | | mass | | | | | |
| | | (C4) | parts by | 0.7 | 0.7 | 0.7 | 0.7 | 0.7 |
| | | | mass | | | | | |
| | | (C5) | parts by | | | | | |
| | | | mass | | | | | |
| | Blue pigment total | | % by | 7.5 | 7.5 | 7.5 | 16.3 | 5.1 |
| | PWC | | mass | | | | | |
| | Black pigment:blue | | (Mass | 1:7.5 | 1:7.8 | 1:7.5 | 1:15.0 | 1:5.1 |
| | pigment | | ratio) | | | | | |
| | White pigment:black | | (Mass | 0.7:1 | 0.7:1 | 0.7:1 | 0.7:1 | 0.7:1 |
| | pigment | | ratio) | | | | | |
| | Total PWC | | % by | 9.2 | 9.5 | 9.2 | 16.7 | 6.7 |
| | | | mass | | | | | |
| Clear | | | | Present | Present | Present | Present | Present |
| Light | Lightness | L*45 | | 4.38 | 3.57 | 4.41 | 3.45 | 4.24 |
| source | Degree of | a*45 | | 0.73 | 0.61 | 1.45 | 1.33 | −0.23 |
| 100%, | redness | | | | | | | |
| assuming | Degree of | b*45 | | −6.13 | −4.89 | −5.25 | −5.34 | −5.68 |
| good | yellowness | | | | | | | |
| weather | Chroma | C*_{ab}45 | | 6.17 | 4.93 | 5.45 | 5.51 | 5.69 |
| Light | Lightness | L*45 | | 0.44 | 0.36 | 0.44 | 0.35 | 0.42 |
| source | Degree of | a*45 | | 0.07 | 0.06 | 0.15 | 0.13 | −0.02 |
| 10%, | redness | | | | | | | |
| assuming | Degree of | b*45 | | −0.61 | −0.49 | −0.52 | 0.53 | −0.57 |
| cloudy | yellowness | | | | | | | |
| weather | Chroma | C*_{ab}45 | | 0.62 | 0.49 | 0.54 | 0.55 | 0.57 |

| Presence or absence of change in | | Present | Present | Present | Present | Present |
|---|---|---|---|---|---|---|
| color impression due to incident | | | | | | |
| light intensity | | | | | | |
| Hiding | ΔE*_{ab}45 | 0.45 | 0.12 | 0.17 | 0.44 | 0.34 |
| property | | | | | | |

| | | | | Example 6 | Example 7 | Example 8 | Example 9 |
|---|---|---|---|---|---|---|---|
| Base | Coloring | (C1) | parts by | 1.0 | 1.0 | 1.0 | 1.0 |
| | pigment | | mass | | | | |
| | | (C2) | parts by | 7.5 | 0.0 | 5.0 | 5.0 |
| | | | mass | | | | |
| | | (C3) | parts by | 0.0 | 7.5 | 2.5 | 2.5 |
| | | | mass | | | | |
| | | (C4) | parts by | 0.7 | 0.7 | 1.0 | 1.5 |
| | | | mass | | | | |
| | | (C5) | parts by | | | | |
| | | | mass | | | | |
| | Blue pigment total | | % by | 7.5 | 7.5 | 7.5 | 7.5 |
| | PWC | | mass | | | | |
| | Black pigment:blue | | (Mass | 1:7.5 | 1:7.5 | 1:7.5 | 1:7.5 |
| | pigment | | ratio) | | | | |
| | White pigment:black | | (Mass | 0.7:1 | 0.7:1 | 1.0:1 | 1.5:1 |
| | pigment | | ratio) | | | | |
| | Total PWC | | % by | 9.2 | 9.2 | 9.5 | 10.0 |
| | | | mass | | | | |
| Clear | | | | Present | Present | Present | Present |
| Light | Lightness | L*45 | | 3.75 | 4.84 | 4.72 | 5.24 |
| source | Degree of | a*45 | | 0.20 | 2.75 | 0.47 | 0.08 |
| 100%, | redness | | | | | | |
| assuming | Degree of | b*45 | | −5.58 | −4.88 | −7.10 | −8.51 |
| good | yellowness | | | | | | |
| weather | Chroma | C*_{ab}45 | | 5.58 | 5.60 | 7.12 | 8.51 |
| Light | Lightness | L*45 | | 0.37 | 0.48 | 0.47 | 0.52 |
| source | Degree of | a*45 | | 0.02 | 0.27 | 0.05 | 0.01 |
| 10%, | redness | | | | | | |
| assuming | Degree of | b*45 | | −0.56 | −0.49 | −0.72 | −0.89 |
| cloudy | yellowness | | | | | | |
| weather | Chroma | C*_{ab}45 | | 0.56 | 0.56 | 0.72 | 0.89 |
| Presence or absence of change in | | | | Present | Present | Present | Present |
| color impression due to incident | | | | | | | |
| light intensity | | | | | | | |
| Hiding | ΔE*_{ab}45 | | | 0.06 | 0.12 | 0.11 | 0.44 |
| property | | | | | | | |

TABLE 2

| | | | | Compar- | Compar- | Compar- | Compar- | Compar- | Compar- | Compar- | Compar- |
|---|---|---|---|---|---|---|---|---|---|---|---|
| | | | | ative | ative | ative | ative | ative | ative | ative | ative |
| | | | | Example 1 | Example 2 | Example 3 | Example 4 | Example 5 | Example 6 | Example 7 | Example 8 |
| Base | Coloring | (C1) | parts by | 0.6 | 3.0 | 0.2 | 3.5 | 2.0 | 0.0 | 1.0 | 1.0 |
| | pigment | | mass | | | | | | | | |
| | | (C2) | parts by | 1.5 | | 1.0 | 17.0 | 5.0 | 5.0 | 0.0 | 5.0 |
| | | | mass | | | | | | | | |
| | | (C3) | parts by | 0.5 | | 0.5 | 8.0 | 2.5 | 2.5 | 2.5 | 2.5 |
| | | | mass | | | | | | | | |
| | | (C4) | parts by | 18.0 | | 0.2 | 2.0 | 0.7 | 0.7 | 0.7 | 0.0 |
| | | | mass | | | | | | | | |
| | | (C5) | parts by | 0.6 | | | | | | | |
| | | | mass | | | | | | | | |
| | Blue pigment total | | % by | 2.0 | — | 1.7 | 24.8 | 7.5 | 7.5 | 2.4 | 7.5 |
| | PWC | | mass | | | | | | | | |
| | Black pigment:blue | | (Mass | 1:3.3 | — | 1:7.5 | 1:7.1 | 1:3.8 | — | 1:2.5 | 1:7.5 |
| | pigment | | ratio) | | | | | | | | |
| | White pigment:black | | (Mass | 30.0:1 | — | 1.0:1 | 0.6:1 | 0.4:1 | — | 0.7:1 | — |
| | pigment | | ratio) | | | | | | | | |
| | Total PWC | | % by | 21.2 | 3.0 | 1.9 | 30.5 | 10.2 | 8.2 | 4.2 | 8.5 |
| | | | mass | | | | | | | | |
| Clear | | | | Present | Present | Present | Present | Present | Present | Present | Present |
| Light | Lightness | L*45 | | 33.82 | 1.10 | 4.42 | 3.18 | 3.48 | 6.49 | 4.96 | 3.07 |
| source | Degree of | a*45 | | | | | | | | | |
| 100%, | redness | | | −6.88 | −0.09 | 0.45 | 0.12 | 0.80 | 6.33 | 1.34 | 1.50 |
| assuming | Degree of | b*45 | | | | | | | | | |
| good | yellowness | | | −17.27 | −0.21 | −7.55 | −3.62 | −3.02 | −21.73 | −3.19 | −2.78 |
| weather | Chroma | C*_{ab}45 | | | | | | | | | |
| | | | | 18.59 | 0.23 | 7.56 | 3.62 | 3.13 | 22.63 | 3.46 | 3.16 |
| Light | Lightness | L*45 | | 7.16 | 0.11 | 0.44 | 0.32 | 0.35 | 0.65 | 0.50 | 0.31 |
| source | Degree of | a*45 | | −2.87 | −0.01 | 0.05 | 0.01 | 0.08 | | | |
| 10%, | redness | | | | | | | | 0.63 | 0.13 | 0.15 |
| assuming | Degree of | b*45 | | −7.96 | −0.02 | −0.76 | −0.36 | −0.30 | | | |
| cloudy | yellowness | | | | | | | | −3.19 | −0.32 | −0.28 |
| weather | Chroma | C*_{ab}45 | | 8.46 | 0.02 | 0.76 | 0.36 | 0.31 | | | |
| Presence or absence of change | | | | Absent | Absent | Present | Absent | Absent | Present | Absent | Absent |
| in color impression due to | | | | | | | | | | | |
| incident light intensity | | | | | | | | | | | |
| Hiding | ΔE*_{ab}45 | | | 0.15 | 0.10 | 11.06 | 0.26 | 0.12 | 4.55 | 0.16 | 0.14 |
| property | | | | | | | | | | | |

Examples 1 to 9, which are examples of the present disclosure, each have a hiding property, and a change in color impression due to incident light intensity was confirmed.

In Comparative Example 1, the lightness L*45 and the chroma C*_{ab}45 at a light source 100% and the lightness L*45, the degree of yellowness b*45, and the chroma C*_{ab}45 at a light source 10% were out of the scope of the present disclosure, and a change in color impression due to incident light intensity was not observed.

In Comparative Example 2, the lightness L*45, the degree of yellowness b*45, and the chroma C*_{ab}45 at a light source 100% were out of the scope of the present disclosure, and a change in color impression due to incident light intensity was not observed.

In Comparative Example 3, the pigment mass concentration of the coloring pigment was out of the scope of the present disclosure, and the hiding property was not sufficiently satisfactory.

In Comparative Examples 4, 5, 7, and 8, the degree of yellowness b*45 and the chroma C*_{ab}45 at a light source 100% were out of the scope of the present disclosure, and a change in color impression due to incident light intensity was not observed.

In Comparative Example 6, the chroma C*_{ab}45 at a light source 100%, and the degree of yellowness b*45 and the chroma C*_{ab}45 at a light source 10% were out of the scope of the present disclosure, and the hiding property was not sufficiently satisfactory.

### INDUSTRIAL APPLICABILITY

The multilayer coating film of the present disclosure has a hiding property, and may exhibit dichroism due to a difference in light intensity, and preferably has a hiding property and may exhibit dichroism due to light intensity even in a solid color. Therefore, the multilayer coating film of the present disclosure is preferably used for coating automobile bodies and the like.

1. A multilayer coating film comprising:
an intermediate coating layer;
a base layer overlaid on the intermediate coating layer; and
a clear layer overlaid on the base layer,
wherein a lightness L*45 is 3 to 10, a degree of yellowness b*45 is −4 or less, and a chroma C*_{ab}45 is 4 to 10, based on a spectral reflectance at a light source 100%,
wherein a lightness L*45 is 3 or less, a degree of yellowness b*45 is −3 to 0, and a chroma C*_{ab}45 is 3 or less, based on a spectral reflectance at a light source 10%, and
wherein a content of a coloring pigment in the base layer is 2.5 parts by mass or more per 100 parts by mass of a solid content of the base layer.

2. The multilayer coating film according to claim 1,
wherein the base layer comprises a resin and one or more blue pigments, and
Wherein a content of the blue pigments in the base layer is 2 to 20 parts by mass in 100 parts by mass of a solid content of the base layer.

3. The multilayer coating film according to claim 2,
wherein the base layer further comprises one or more black pigments,
wherein a content of the black pigments in the base layer is 0.5 to 2 parts by mass in 100 parts by mass of a solid content of the base layer, and
a mass ratio of the black pigments to the blue pigments (black pigments: blue pigments) is 1:4-1:15.

4. The multilayer coating film according to claim 3,
wherein the base layer further comprises one or more white pigments,
Wherein a content of the white pigments in the base layer is 0.25 to 1.5 parts by mass in 100 parts by mass of a solid content of the base layer, and
a mass ratio of the white pigments to the black pigments (white pigments: black pigments) is 0.5:1-1.5:1.

5. The multilayer coating film according to claim 1, wherein a color difference ΔE*_{ab} between a color exhibited when the base layer is formed on a substrate layer u1 having a lightness L*45 of 20 to 30 and a color exhibited when the base layer is formed on a substrate layer u2 having a lightness L* of 80 or more, in the base layer, is 3.0 or less.

6. The multilayer coating film according to claim 2, wherein a color difference ΔE*_{ab} between a color exhibited when the base layer is formed on a substrate layer u1 having a lightness L*45 of 20 to 30 and a color exhibited when the base layer is formed on a substrate layer u2 having a lightness L* of 80 or more, in the base layer, is 3.0 or less.

7. The multilayer coating film according to claim 3, wherein a color difference ΔE*_{ab} between a color exhibited when the base layer is formed on a substrate layer u1 having a lightness L*45 of 20 to 30 and a color exhibited when the base layer is formed on a substrate layer u2 having a lightness L* of 80 or more, in the base layer, is 3.0 or less.

8. The multilayer coating film according to claim 4, wherein a color difference ΔE*_{ab} between a color exhibited when the base layer is formed on a substrate layer u1 having a lightness L*45 of 20 to 30 and a color exhibited when the base layer is formed on a substrate layer u2 having a lightness L′ of 80 or more, in the base layer, is 3.0 or less.
